(19) United States
(12) Patent Application Publication
(10) Pub. No.: US 2018/0254000 A1
(43) Pub. Date: Sep. 6, 2018

(54) EROSIAL CONTROL DEVICE ADVERTISING AND METHOD OF SUBSIDIZING CONSTRUCTION PROJECTS

(71) Applicant: Diane T. Baum, Baton Rouge, LA (US)

(72) Inventor: Diane T. Baum, Baton Rouge, LA (US)

(21) Appl. No.: 15/908,906

(22) Filed: Mar. 1, 2018

Related U.S. Application Data
(60) Provisional application No. 62/465,478, filed on Mar. 1, 2017.

(51) Int. Cl. G09F 23/00; E01F 7/00; G09F 13/00; G06Q 90/00; E02D 17/20

(52) U.S. Cl. CPC G09F 23/00; E01F 7/00; E02D 17/202; G06Q 90/00; G09F 13/00

(57) ABSTRACT

A method for subsidizing and/or reducing the cost of construction at a site that comprises installing an erosion control product on a site, providing advertising space either on or attached to the erosion control product, and using any moneys generated from the advertising space to either subsidize and/or provide cost-sharing benefits to reduce the cost of construction for the site. A device including a silt fence and advertising space is also provided.

### CROSS REFERENCE TO RELATED APPLICATIONS

The application claims the benefit of and priority to U.S. Patent Provisional Application No. 62/465,478, “Erosion Control Device Advertising and Method of Subsidizing Construction Projects” filed Mar. 1, 2017.

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### BRIEF DESCRIPTION OF THE DRAWINGS

FIG. 1 is a depiction of one embodiment of the invention in which the advertising copy is placed above and is attached to the erosion control device.

FIG. 2 is a depiction of one embodiment of the invention in which the advertising copy is placed above and is attached to the erosion control device. The embodiment in FIG. 2 also shows lights on the structure.

### DETAILED DESCRIPTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies. Although the terms “step” and/or “block” or “module” etc. might be used herein to connote different components of methods or systems employed, the terms should not be interpreted as implying any particular order among or between various steps herein disclosed unless and except when the order of individual steps is explicitly described.

Furthermore, the described features, structures, or characteristics may be combined in any suitable manner in one or more embodiments. In the following description, numerous specific details are provided, such as examples of erosion control products and advertising spaces. One skilled in the relevant art will recognize, however, that the methods of advertising including erosion and sedimentation control techniques and methods of subsidizing the funding of construction using advertising on erosion and sedimentation control techniques may be practiced without one or more of the specific details, or with other methods, components, materials, and so forth. In other instances, well-known structures, materials, or operations are not shown or described in detail to avoid obscuring aspects of the invention.

Described herein are methods of advertising including erosion and sedimentation control techniques and methods of subsidizing the funding of construction using advertising on erosion and sedimentation control techniques. Erosion and sedimentation control techniques are regulated by local, state, and federal governments to implement Best Management Practices (BMPs) on construction sites. Construction sites usually require storm-water construction permits which control the loss of sediment, debris, water discharge, and contaminants which could be discharged into waterways, storm-water tributaries, and/or municipal controlled waterways from activities that occur on the construction site.

BMPs come in various forms and types and are not prescribed by the EPA or state governments. However, BMPs can be approved by the local department of transportation and development reviewers, or similar state, city, or federal governmental entities or personnel, for their effectiveness on construction sites. Typically, construction sites will utilize an erosion control called “silt fencing” on their sites. Silt fencing can be made of different material and/or fabrics. Silt fencing can be installed in various ways. For example, silt fencing can be installed with wire or without wire, or with different heights and/or different size stakes.

Subsidizing and/or Cost Sharing through Erosion Control Products at Construction Sites. In one embodiment, the method comprises installing an erosion control product on a site, providing advertising space either on or attached to the erosion control product, and using any moneys generated from the advertising space to either subsidize or provide cost-sharing benefits to reduce at least one aspect of the cost of construction for the site. Alternatively, the method can be used to eliminate or minimize the costs otherwise used for this item in compliance with environmental regulations that pertain to local, state or federal requirements. The arrangement for payment of the advertisements can be with government entities or private companies. In one embodiment the advertising revenue can be used to provide an enhance erosion control that would not have been possible otherwise.

A site includes, but is not limited to, any construction site or other site that utilizes erosion control products, whether required by any governmental authority, regulation, law, or not. In one embodiment, the site is a private site. In another embodiment, the site is a municipal site. In yet another embodiment, the site is a government site.

Erosion control products can be any product that is either designed or functions to control the loss of sediment, debris, water discharge, and contaminants which could be discharged into waterways, storm-water tributaries, or municipal controlled waterways from activities that occur on the site. In one embodiment, the erosion control product is a silt fence. However, those skilled in the art will know to adapt the method to other types of erosion control devices. These various types of erosion control devices include, but are not limited to, modular interlocking barriers, concrete barriers, net barriers, and tube barriers that employ fabric tubes filled with sand or dirt.

The advertising space comprises any materials to which advertisements may be placed or printed, which are either now known or discovered in the future. These include traditional billboards, vinyl, laminates, wood, plastics, etc.

In one embodiment, at least a portion of the funds generated from the advertising space are used to subsidize and/or provide a cost-sharing benefit to reduce, or even completely cover the cost for portions of the construction occurring on the site.

In one embodiment, the method further comprises working with municipalities, governments, municipal entities, governmental entities, and/or regulators whereby an entity other than the contractor performing the work will perform the erosion control work by setting up the erosion control products. This third party entity may be a private company.

In another embodiment, the method comprises installing and maintaining an erosion control product on a site, providing advertising space either on or attached to the erosion control product, using any moneys generated from the advertising space to either subsidize and/or provide cost sharing benefits to reduce the cost of construction for the site, and using the erosion control product to control the storm-water plans and/or permits in the area. The advertising copy can be added on a display attached to the erosion control device or in some embodiments the advertising copy may be placed directly on the device. The choice of these embodiments will be a balance between visibility of the advertising copy and preservation of the capabilities of the erosion control device.

In still another embodiment, the advertising is included on both sides of the erosion control product.

In still another embodiment, the advertising space comprises a stable and/or high grade material, which insures that the advertisements are stable and enhance the advertising appeal while maintaining the erosion control and original technique of the erosion control product.

In one embodiment the advertising copy can be printed on a film which can then be adhered to the erosion control device.

Advertising and/or Public Information on Erosion Control Products at Construction Sites.

In one embodiment, the method comprises installing an erosion control product on a site, providing advertising space either, and using the advertising space to provide advertising and/or public information. The advertising space would be located above or in front of the erosion control product.

A site includes, but is not limited to, any construction site or other site that utilizes erosion control products, whether required by any governmental authority, regulation, law, or not. In one embodiment, the site is a private site. In another embodiment, the site is a municipal site. In yet another embodiment, the site is a government site.

Erosion control products can be any product that is either designed or functions to control the loss of sediment, debris, water discharge, and contaminants which could be discharged into waterways, storm-water tributaries, and/or municipal controlled waterways from activities that occur on the site. In one embodiment, the erosion control product is a silt fence.

The advertising space comprises any materials to which advertisements may be placed or printed, which are either now known or discovered in the future. These include traditional billboards, vinyl, laminates, wood, plastics, etc.

In one embodiment the advertising space is attached and/or otherwise physically connected to the erosion control product. In another embodiment, the advertising space is removably attached and/or otherwise physically connected to the erosion control product. In another embodiment, the advertising space is adjacent to the erosion control device. In another embodiment, the advertising copy is integrated into the erosion control product.

In one embodiment, the advertising space is continuous along at least a substantial portion of the erosion control product. In another embodiment, the advertising space is placed at intervals along the erosion control product.

In one embodiment, the advertising is dedicated solely to one advertiser. In one embodiment, the advertising is continuous and is dedicated solely to one advertiser. In another embodiment, the advertising includes advertisements from at least two or more advertisers. In another embodiment, the advertising includes advertisements from at least two or more advertisers and is repetitive, in that at least two advertisements are alternated.

In one embodiment, different sections of the erosion control product have different advertisements. In another embodiment, the erosion control product comprises silt fencing and there are various ads or public information that is located along the silt fencing itself.

In one embodiment, the advertising space is located above the erosion control product and is attached and/or connected, whether removably or permanently, to the erosion control product with poles and/or stakes. In this embodiment, the advertising space can be a hard-back billboard or a flexible material. The poles and/or stakes are used to hold the advertising space in place. In another embodiment, the poles and/or stakes are used to hold both the advertising space and the erosion control product in place. This would not degrade or diminish the current effectiveness of the erosion control product or the erosion control product's objective. Additionally, the stake may enhance the stability of the erosion control product by adding more reinforcing poles and stakes.

The advertising space may also comprise or be attached and/or connected to many other types of best management practices to which advertising could be effectively added to an erosion control product. This includes erosion control products made of various fabrics, Styrofoam fence, wire-backed fence, low wattles placed on driveways, etc.

In another embodiment, the advertising space is used to reinforce the erosion control product. In this embodiment, the addition of the advertising space to the erosion control product makes the erosion control product stronger and extends the useful life of the erosion control product. An example would be adding additional stakes and/or poles either to an erosion control product or adjacent to the erosion control product, where the advertising space would be located on the additional stakes and/or poles, and the use of these additional stakes and/or poles increases the durability of the erosion control product. A further example would include adding additional stakes and/or poles either to a silt fence or adjacent to the silt fence, where the advertising space would be located on the additional stakes and/or poles, and the use of these additional stakes and/or poles increases the durability of the silt fence. In a further example the advertising space is only a short distance from the silt fence but occupies the same “dead space” part of the construction zone as the erosion control product.

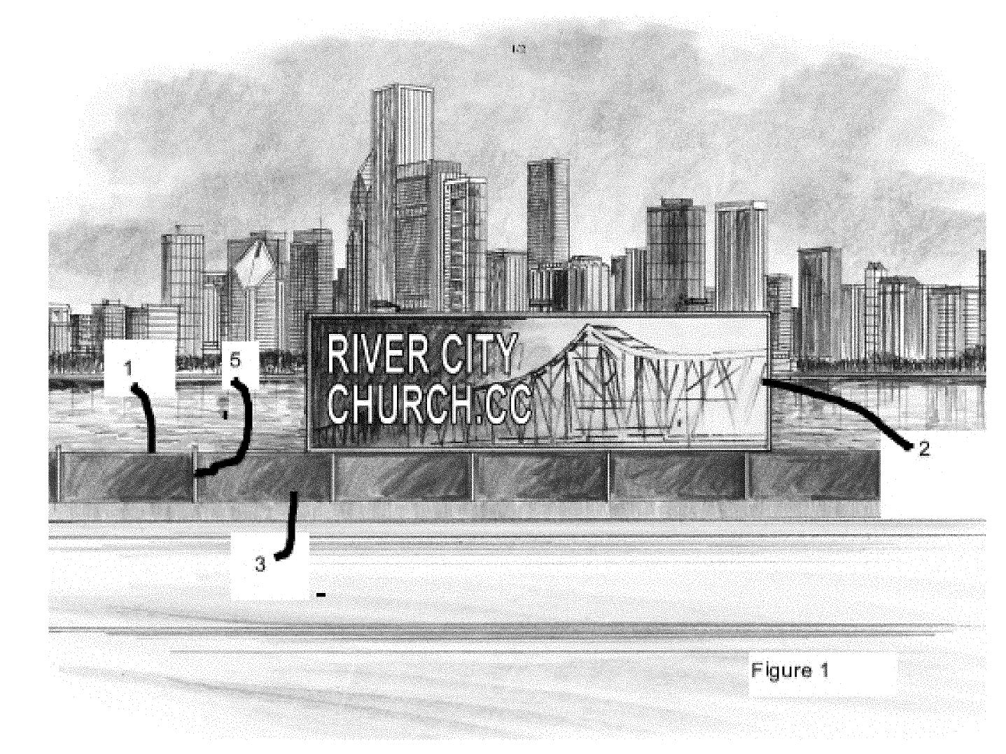

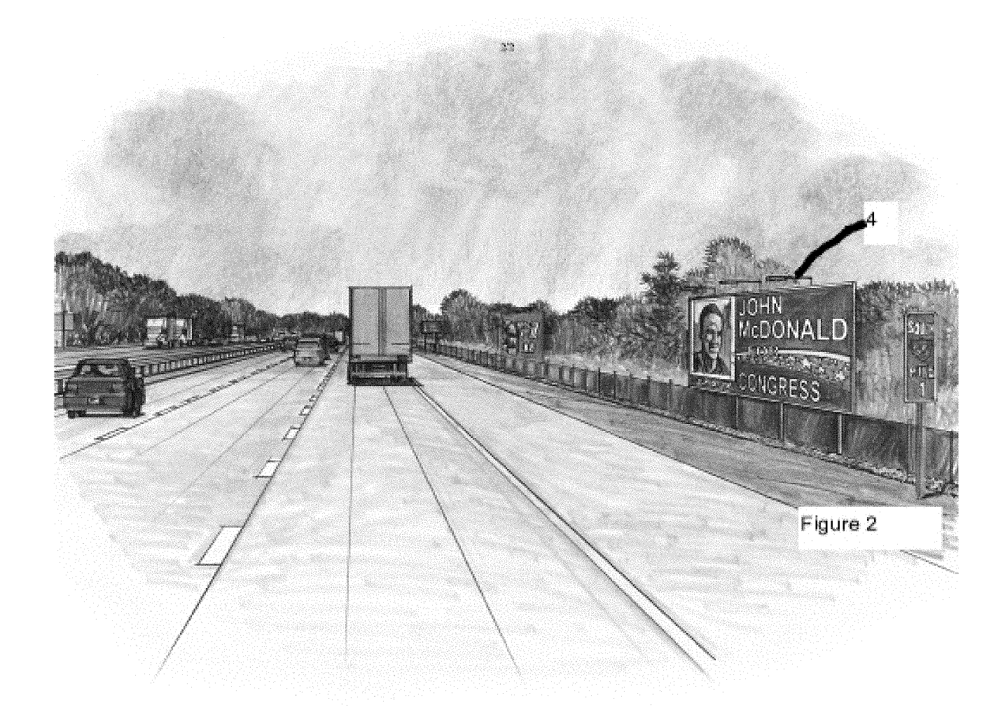

Referring to FIG. 1, the erosion control product is a silt fence 1 that is made up of fabric sheeting 3 and stakes 5. Advertising space 2 is located above the erosion control product and is attached to the erosion control product. In this embodiment, the advertising space is a hard-back billboard or a flexible material with a frame. Referring to FIG. 2, the embodiment depicted includes lights 4.

In still another embodiment, the advertising is included on both sides of the erosion control product.

In still another embodiment, the advertising space comprises a stable and/or high grade material, which insures that the advertisements are stable and enhance the advertising appeal while maintaining the erosion control and original technique of the erosion control product.

Lights 4 in FIG. 2 illuminate the advertising space to ensure that is visible for 24 hour viewing. The lights can consist of poles that attached or unattached to the erosion control device. The structure used to accommodate the lights may also contribute to the structural integrity of the erosion control device.

The method may also include integration of the erosion control storm water plan, inspections, and reports with the costs associated with this erosion control advertising method. All of the erosion control consulting work, including the Storm Water Pollution Prevention Plan (SWPPP) can be included with installation of the advertising and erosion control device. This arrangement would allow the contractor to ensure compliance with regulatory requirements while reducing costs paid to the third party consultant.

An advantage of the novel method disclosed herein is the removal of the erosion control responsibility from the contractors or government. Work would be given to independent third-parties through contracts with owners, government entities, or consulting engineers. This would be advantageous as compared to current arrangements which are based on the lowest bidder and result in low quality.

For the purpose of understanding the methods of advertising including erosion and sedimentation control techniques and methods of subsidizing the funding of construction using advertising on erosion and sedimentation control techniques, references are made in the text to exemplary embodiments of methods of advertising including erosion and sedimentation control techniques and methods of subsidizing the funding of construction using advertising on erosion and sedimentation control techniques, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the methods of advertising including erosion and sedimentation control techniques and methods of subsidizing the funding of construction using advertising on erosion and sedimentation control techniques may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change to the basic function to which it is related.

1. A method of subsidizing the cost of construction comprising:
a. installing an erosion control product on a site;
b. providing an advertising space attached to the erosion control product, said advertising space comprising advertisements paid for by an advertiser; and
c. using at least a portion of money received from said advertiser for said advertisement to subsidize or reduce the cost of at least one aspect of construction occurring at said site.

2. The method of claim 1, wherein said erosion control product comprises a silt fence.

3. The method of claim 1, wherein said site comprises a private construction site.

4. The method of claim 1, wherein said site comprises a municipal construction site.

5. The method of claim 1, wherein said site comprises a government construction site.

6. A device for erosion control and advertising at a construction site, said erosion control device comprising:
a. a silt fence, said silt fence comprising stakes and flexible sheeting
b. an advertising space attached to the erosion control product, said advertising space comprising at least one advertisement

7. The device of claim 6, further comprising lights to illuminate said advertising space.
